(19) United States
(12) Patent Application Publication
(10) Pub. No.: US 2023/0304851 A1
(43) Pub. Date: Sep. 28, 2023

(54) UNCONFIRMED SOUND EXTRACTION DEVICE, UNCONFIRMED SOUND EXTRACTION SYSTEM, UNCONFIRMED SOUND EXTRACTION METHOD, AND RECORDING MEDIUM

(71) Applicant: NEC Corporation, Minato-ku, Tokyo (JP)

(72) Inventor: Yutaka YANO, Tokyo (JP)

(73) Assignee: NEC Corporation, Minato-ku, Tokyo (JP)

(21) Appl. No.: 18/019,161

(22) PCT Filed: Jun. 29, 2021
(86) PCT No.: PCT/JP2021/024446

§ 371 Date: Feb. 1, 2023

(30) Foreign Application Priority Data
Aug. 13, 2020 (JP) 2020-136554

(51) Int. Cl. G01H 9/00; H04R 23/00

(52) U.S. Cl. CPC G01H 9/004; H04R 23/008

(57) ABSTRACT

In, for example, the overly vast ocean, it would be economically impossible to use common sensors to construct a sensor network for capturing a rare phenomenon. This invention addresses the problem of providing an unconfirmed sound extraction device, and the like, for facilitating the monitoring of sound caused by an infrequently occurring phenomenon. This unconfirmed sound extraction device comprises an unconfirmed sound extraction unit for extracting, from sound data that has been acquired using an optical fiber and is related to sound at various positions on the optical fiber, unconfirmed sound information representing unconfirmed sound data, which is of the sound data and is on a sound having a cause that cannot be estimated, at a sound data acquisition time and location, and an output unit for outputting the unconfirmed sound information.

### TECHNICAL FIELD

The present invention relates to a device and the like that extract a sound.

### BACKGROUND ART

While the sea occupies seventy percent of the earth surface, it is difficult to detect an abnormal event occurring in the sea. A range viewable from a shore of the land or a ship on the ocean is merely approximately 20 km. A satellite has difficulty in acquiring a small event and performs monitoring intermittently. From such points, there is a possibility that many abnormal events occurring in a short period in the open ocean cannot be detected. For example, it is possible that a fall of a meteorite or the like onto the sea surface, some sort of an explosion phenomenon in which a mark does not remain, and the like may be overlooked.

As one method of monitoring these events, it is conceivable to perform constant observation by installing an underwater microphone in the open ocean. In water, a sound reaches further than in air. When a heavy object falls onto the sea bottom, a vibration spreads through the land surface. A large vibration reaches the land and can be detected by a seismometer, but it is difficult to detect a small vibration when an observation point is distant, and therefore it is desirable to detect such a small vibration in a location close to an occurrence point.

It is known that optical fiber sensing is effective as a means for detecting a sound occurring in a periphery of an optical fiber. Japanese patent application No. 2020-013946, for example, discloses a method of acquiring, by using distributed acoustic sensing (DAS), a sound in an optical fiber periphery. NPL 1 discloses a principle of DAS.

It is conceivable that optical fiber sensing enables monitoring of various sounds. It is supposable that a sound intended to be a monitoring target also includes, for example, a sound of an event having a small appearance frequency, such as a fall of a meteorite or an airplane onto the sea surface and a collapse of an iceberg.

### CITATION LIST

### Non Patent Literature

[NPL 1] R. Posey Jr, G. A. Johnson and S. T. Vohra, “Strain sensing based on coherent Rayleigh scattering in an optical fibre”, ELECTRONICS LETTERS, 28 Sep. 2000, Vol. 36 No. 20, pp. 1688 to 1689

### SUMMARY OF INVENTION

### Technical Problem

As described in Background Art, it is difficult to install, in the vast sea, a sensor network capable of detecting an abnormal event occurring in the sea, from a point of view of collection of observation data, supply of device power, magnitude of a burden on maintenance or the like.

In a sound based on an event having a small appearance frequency, information for classifying a sound source is frequently insufficient, and in this case, it is unable to classify a sound source, and therefore it is difficult to handle such a sound as a monitoring target.

An object of the present invention is to provide an unconfirmed sound extraction device and the like that ease monitoring of a sound an occurrence cause of which is an event having a small appearance frequency.

### Solution to Problem

An unconfirmed sound extraction device according to the present invention includes: an unconfirmed sound extraction unit that extracts, from sound data being acquired by an optical fiber, the sound data being data relating to a sound in each of locations of the optical fiber, unconfirmed sound information representing unconfirmed sound data being the sound data of the sound an occurrence cause of which is not estimated at a time and in the location of acquisition of the sound data; and an output unit that outputs the unconfirmed sound information.

### Advantageous Effects of Invention

The unconfirmed sound extraction device and the like according to the present invention ease monitoring of a sound an occurrence cause of which is an event having a small appearance frequency.

### BRIEF DESCRIPTION OF DRAWINGS

FIG. 1 is a conceptual diagram illustrating a configuration example of an unconfirmed sound extraction system according to the present example embodiment.

FIG. 2 is a conceptual diagram illustrating an example of a manner of installing an optical cable of an unconfirmed sound extraction system.

FIG. 3 is a diagram explaining a sieving operation for RAW data by an unconfirmed sound information processing unit.

FIG. 4 is a conceptual diagram illustrating a configuration example of the unconfirmed sound information processing unit.

FIG. 5 is a conceptual diagram illustrating a processing flow example of processing to be executed by a classification/extraction data sound extraction unit.

FIG. 6 is a conceptual diagram (No. 1) illustrating a third specific example of an operation to be performed by a known sound classification unit.

FIG. 7 is a conceptual diagram (No. 2) illustrating the third specific example of the operation to be performed by the known sound classification unit.

FIG. 8 is a conceptual diagram (No. 1) illustrating a fourth specific example of an operation to be performed by the known sound classification unit.

FIG. 9 is a conceptual diagram (No. 2) illustrating the fourth specific example of the operation to be performed by the known sound classification unit.

FIG. 10 is a block diagram illustrating a minimum configuration of an unconfirmed sound extraction device according to the example embodiment.

### EXAMPLE EMBODIMENT

An unconfirmed sound extraction device and the like according to the present example embodiment acquire sound data, by using DAS explained in the paragraph of Background Art and by further using an optical fiber included in a submarine cable laid in the sea for another purpose such as optical transmission. The unconfirmed sound extraction device and the like extract unconfirmed sound data being remaining sound data acquired by excluding sound data in which an occurrence cause can be classified from the acquired sound data and outputs the extracted unconfirmed sound data. A monitoring worker or the like can seek, from unconfirmed sound data being further-narrowed sound data, confirmation of presence of a sound based on an event having a small appearance frequency, for example, such as a fall of a meteorite or an airplane. Thereby, the unconfirmed sound extraction device eases monitoring of a sound based on an event having a small appearance frequency.

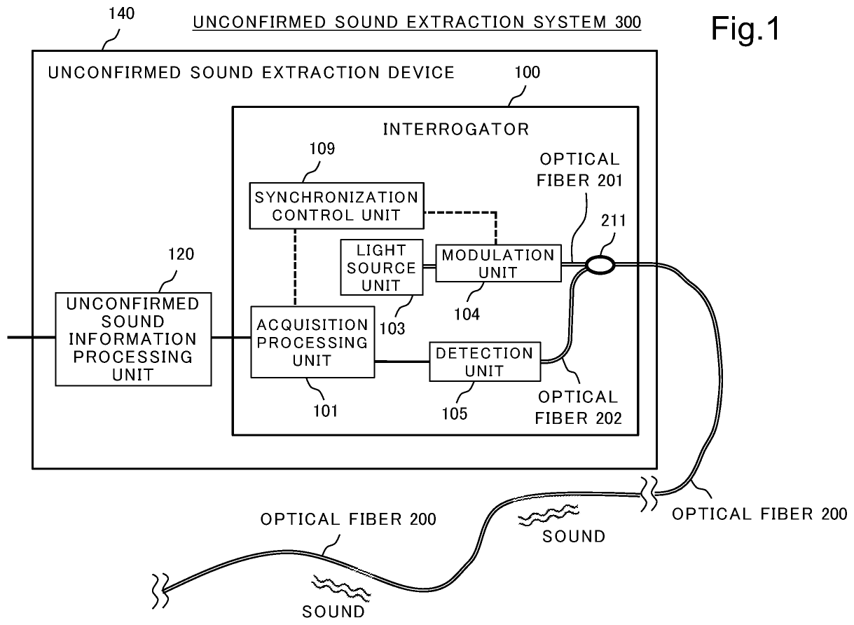

FIG. 1 is a conceptual diagram illustrating a configuration of an unconfirmed sound extraction system 300 being an example of the unconfirmed sound extraction system according to the present example embodiment. The unconfirmed sound extraction system 300 includes an unconfirmed sound extraction device 140 and an optical fiber 200. The unconfirmed sound extraction device 140 includes an interrogator 100 and an unconfirmed sound information processing unit 120.

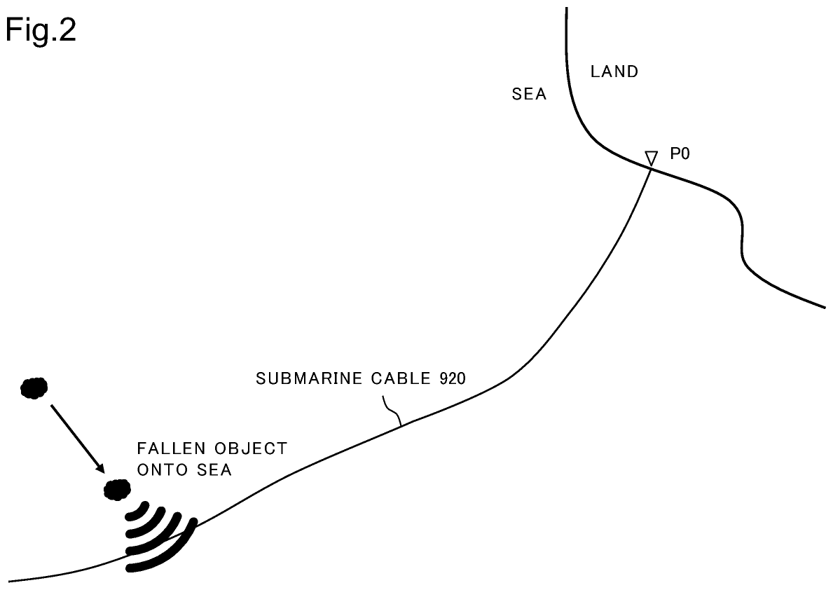

FIG. 2 is a conceptual diagram illustrating an example of a manner of installing the unconfirmed sound extraction system 300 in FIG. 1.

A submarine cable 920 is, for example, a general submarine cable used for a purpose other than extraction of an unconfirmed sound such as optical transmission. The submarine cable 920 is installed on the sea bottom directed from a location P0 being a landing point to offshore.

The interrogator 100 in FIG. 1 is installed, for example, near the location P0, together with a device for optical transmission. The unconfirmed sound information processing unit 120 may be installed near the interrogator 100 or may be installed away from the interrogator 100.

The optical fiber 200 in FIG. 1 is any one of a plurality of optical fibers included in the submarine cable 920. The optical fiber 200 is a general optical fiber, and an optical fiber included in a submarine cable or the like, which are installed for an application such as optical transmission other than extraction of an unconfirmed sound, is usable. A general optical fiber generates backward scattering light subjected to a change based on an environment such as presence of a vibration including a sound. The backward scattering light typically results from Rayleigh backward scattering. In this case, the change is mainly a change of a phase (a phase change).

The optical fiber 200 may be an optical fiber in which a plurality of optical fibers are connected by an amplification repeater or the like. A cable including the optical fiber 200 may be connected between an optical communication device, which is not illustrated, including the interrogator 100 and another optical communication device.

The submarine cable 920 may serve also for another application such as optical transmission, a cable-type wave recorder, and a cable-type ocean-bottom seismometer or may be a dedicated cable that extracts an unconfirmed sound. The submarine cable 920 includes a plurality of optical fiber core wires in a cable, and even in same optical fiber core wires, wavelengths are caused to be different from each other, and thereby the unconfirmed sound extraction system 300 can be caused to coexist with another optical cable system.

### <Operation of Interrogator 100>

The interrogator 100 is an interrogator for performing optical fiber sensing based on an OTDR method. Herein, OTDR is an abbreviation of time-domain reflectometry. Such an interrogator is explained, for example, in Japanese Patent Application No. 2020-013946 described above.

The interrogator 100 includes an acquisition processing unit 101, a synchronization control unit 109, a light source unit 103, a modulation unit 104, and a detection unit 105. The modulation unit 104 is connected to the optical fiber 200 via an optical fiber 201 and an optical coupler 211 and the detection unit 105 is connected to the optical fiber 200 via the optical coupler 211 and an optical fiber 202.

The light source unit 103 includes a laser light source and causes a continuous laser beam to enter the modulation unit 104.

The modulation unit 104 is synchronized with a trigger signal from the synchronization control unit 109, performs, for example, amplitude modulation for a laser beam being continuous light incident from the light source unit 103, and thereby generates probe light having a sensing signal wavelength. The probe light has, for example, a pulse shape. The modulation unit 104 transmits probe light to the optical fiber 200 via the optical fiber 201 and the optical coupler 211.

The synchronization control unit 109 also transmits a trigger signal to the acquisition processing unit 101 and reports what piece of data being input via continuous analog/digital (A/D) conversion indicates a time original point.

When the transmission is performed, return light from each location of the optical fiber 200 reaches the detection unit 105 via the optical fiber 202 from the optical coupler 211. Return light from each location of the optical fiber reaches the interrogator 100 in a shorter time after probe light is transmitted as the return light comes from a location closer to the interrogator 100. When a certain location of the optical fiber 200 is subjected to an influence on an environment such as presence of a sound, in backward scattering light generated in the location, a change from probe light at a time of transmission occurs due to the environment. When the backward scattering light is Rayleigh backward scattering light, the change is mainly a phase change.

Return light in which the phase change is occurring is detected by the detection unit 105. A method for the detection includes well-known synchronous detection and delay detection, and any either of the methods is usable. A configuration for performing phase detection is well-known, and therefore, herein, the explanation is omitted. An electric signal (detection signal) acquired by detection represents a degree of a phase change by an amplitude or the like. The electric signal is input to the acquisition processing unit 101.

The acquisition processing unit 101 first A/D-converts the above-described electric signal into digital data. Next, the acquisition processing unit 101 determines a phase change, from the last measurement, of light scattered and returned in each point of the optical fiber 200, for example, as a difference from the last measurement in the same point. The signal processing is a general technique for DAS, and therefore detailed explanation is omitted.

The acquisition processing unit 101 derives, in sensor locations of the optical fiber 200, data having a form similar to data acquired by virtually arranging dot-shaped electric sensors in a row. The data are virtual sensor-array output data acquired as a result of signal processing and thereafter, are referred to as RAW data for explanation simplification. The RAW data are data representing an instant intensity (waveform) of a sound detected by an optical fiber at each time and in each point (sensor location) of the optical fiber 200. The RAW data are explained, for example, in the paragraph of Background Art of Japanese Patent Application No. 2020-013946 described above. The acquisition processing unit 101 outputs the RAW data to the unconfirmed sound information processing unit 120.

### <Operation Outline of Unconfirmed Sound Information Processing Unit 120>

The unconfirmed sound information processing unit 120 previously stores a classification condition for finding and classifying a known sound from RAW data being input from the acquisition processing unit 101. A classification condition includes, as a detection condition, a feature unique to a known sound.

The unconfirmed sound information processing unit 120 performs the classification in order to extract, from the RAW data, a sound of interest such as a falling sound of a meteorite, sieves a known sound of interest and a sound in which an occurrence cause is unknown, and outputs the sieved sounds. Hereinafter, sound data which are not capable of being classified due to an unknown occurrence cause are referred to as “unconfirmed sound data”.

There are various sounds and vibrations (hereinafter, simply referred to as “sounds”) in the sea. Such sounds include a sound in which a type of an occurrence source is identified relatively easily. There are, for example, a sound generated by waves on the sea surface, sounds generated by various types of marine creatures, a marine navigation sound of a ship, a sound of a fish detector, a sound of gunfire of an air gun to be used for a marine geological survey or the like, an earthquake, and the like. The number of samples of these pieces of sound data is abundant, and therefore a unique feature is found and determined as a classification condition, and thereby classification can be automatically performed. A type of a sound which can be classified in this manner is referred to as “a sound which is known (a known sound)” herein.

Sound data collected in the actual sea also include many sounds of unknown cause which is not capable of being classified by a classification function. Sounds of unknown cause may include a sound of interest to a monitoring person. For example, a falling sound of a meteorite has a rare occurrence frequency and there is substantially no sample for sound data, and therefore it is difficult to artificially perform a simulation and as a result, it is difficult to prepare a classification condition. Therefore, automatic classification is not performed, and therefore it is supposed that an occurrence cause is sieved into an unknown sound.

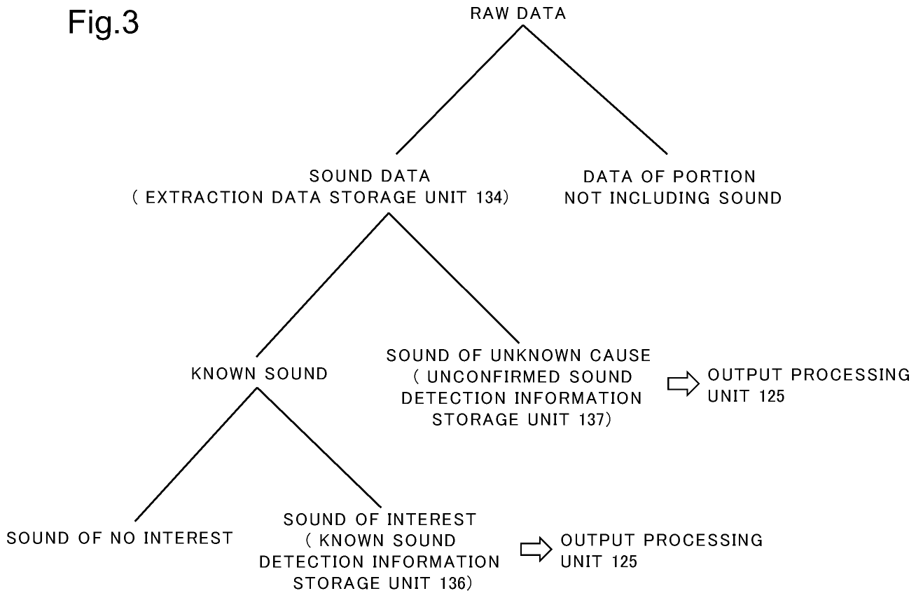

Sieving of sound data explained above is schematically illustrated in FIG. 3. The RAW data are divided into a portion including a certain sound and a portion not including any sound. The Raw data determined as including a certain sound are temporarily stored in an extraction data storage unit 134 to be described later.

Sounds included in the RAW data are divided into a plurality of known sounds and a sound of unknown cause. Sound data of the sound of unknown cause are temporarily stored in an unconfirmed sound detection information storage unit 137 to be described later. The known sounds are further divided into a sound of a type of interest to a monitoring person and a sound of a type of no interest. The sound of a type of interest to a monitoring person is stored in a known sound detection information storage unit 136 to be described later.

The data stored in the unconfirmed sound detection information storage unit 137 and the known sound detection information storage unit 136 are transmitted to the output processing unit 125 and are output.

With regard to sound data stored in the known sound detection information storage unit 136, there is no classification condition in an initial stage of operation start of the unconfirmed sound information processing unit 120 and it is not capable of performing automatic classification, and therefore manual sieving is required. However, when detection cases are accumulated and a unique feature is found, detection may be performed based on automatic classification by using the unique feature as a classification condition.

### <Outline of Configuration and Processing of Unconfirmed Sound Information Processing Unit 120>

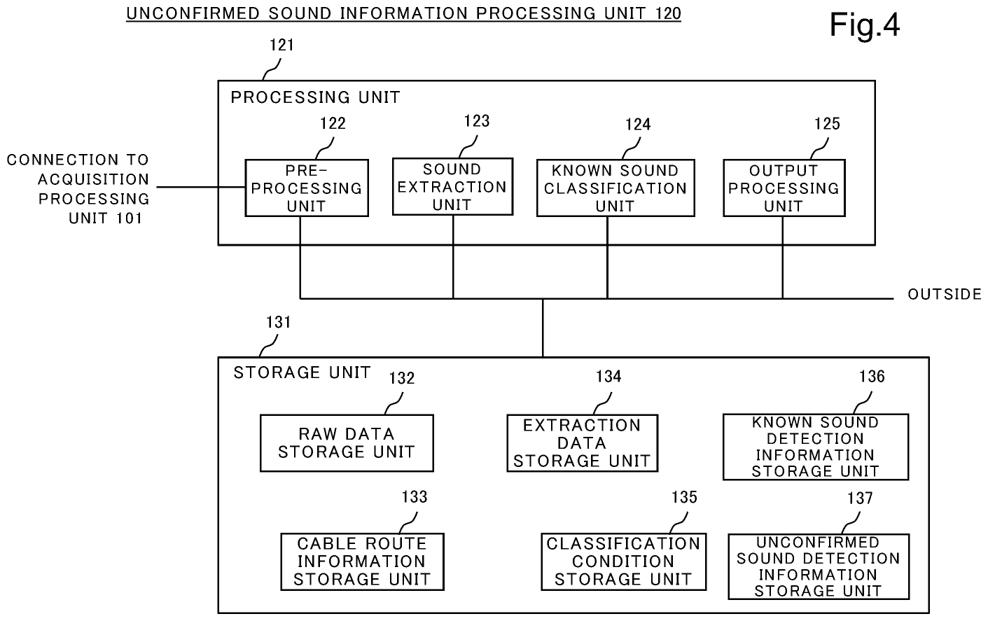

FIG. 4 is a conceptual diagram illustrating a configuration example of the unconfirmed sound information processing unit 120. The unconfirmed sound information processing unit 120 includes a processing unit 121 and a storage unit 131.

The processing unit 121 includes a pre-processing unit 122, a sound extraction unit 123, a known sound classification unit 124, and an output processing unit 125. The storage unit 131 includes a RAW data storage unit 132, a cable route information storage unit 133, an extraction data storage unit 134, a classification condition storage unit 135, a known sound detection information storage unit 136, and an unconfirmed sound detection information storage unit 137.

The above-described RAW data are input to the pre-processing unit 122 from the acquisition processing unit 101 in FIG. 1. The RAW data are, as described above, data representing an instant intensity (waveform) of a sound detected by an optical fiber at each time and in each measurement point (sensor location) of the optical fiber 200.

The sound extraction unit 123 extracts, for example, based on input of start information from an outside, sound data having any sound with respect to RAW data in a predetermined time range and in a predetermined distance range and stores the extracted sound data in the extraction data storage unit 134. Thereby, a data portion not having a possibility of a peculiar sound is excluded and a total data amount is decreased, and thereby a load on the following data processing is reduced.

The known sound classification unit 124 classifies sound data of a known sound from sound data stored in the extraction data storage unit 134. The known sound classification unit 124 performs the classification, based on a classification condition previously stored in the classification condition storage unit 135. Herein, the classification condition is information in which a type of a sound and information characteristically appearing with respect to the sound are combined.

Herein, the type of a sound is information representing a type of a sound source, whether to be a sound generated at what timing, whether to be a sound to be subjected to same sound integration processing to be described later, and the like. The known sound classification unit 124 stores classified sound data of a known sound (known sound data) in the known sound detection information storage unit 136 and stores sound data having not been capable of being classified in the unconfirmed sound detection information storage unit 137.

The output processing unit 125 reads, for example, in accordance with instruction information from an outside, sound data of an unconfirmed sound (unconfirmed sound data) in a predetermined time range and in a predetermined sensor location range from the unconfirmed sound detection information storage unit 137 and outputs the read sound data. Alternatively, the output processing unit 125 reads, for example, in accordance with instruction information from an outside, known sound date in a predetermined time range and in a predetermined sensor location range from the known sound detection information storage unit 136, and outputs the read sound data. An output destination for output of these pieces of sound data is, for example, an external display, a printer, or a communication device. An output destination of the output processing unit 125 may be a server or the like. The server or the like may perform, when sound data of an unconfirmed sound (unconfirmed sound data) or a known sound of interest is extracted, an operation for transmitting, via communication, the unconfirmed sound data or known sound data and information including an occurrence location and an occurrence time of the unconfirmed sound data or the known sound data to a previously registered computer or terminal. A type of sound data to be recorded/stored is desirably settable according to an application and a situation.

The unconfirmed sound information processing unit 120 further includes the following processing and function. First, provided is a function of automatically excluding, from sound data classified into unconfirmed sound data, sound data in which a cause is identified based on information from an external system. As such sound data to be deleted, conceivable are sound data of a sound, for example, such as a sound associated with marine construction, an explosion sound of a military exercise or the like, a sound of thunder, an earthquake, and an explosion of an underwater volcano (separately recognized). The information from the above-described external system may be used in order to increase accuracy of automatic classification in the known sound classification unit 124. In particular, a sound resulting from an activity of a person, such as construction and a military exercise, is effective in order to increase classification accuracy.

The unconfirmed sound information processing unit 120 may include a function of assisting a monitoring worker in performing cause analysis for sound data sieved as sound data relating to an unconfirmed sound of unknown cause. As such a function, for example, it is conceivable to perform mapping combined with map information and visualize and output the resultant. As such a function, alternatively, for example, it is conceivable to automatically acquire information of a ship or an airplane passing through an occurrence source vicinity of a sound from a location information system of the ship or the airplane and thereby, to assist transmission of a notification that contact is required when anything is witnessed. As such a function, alternatively, for example, it is conceivable to examine whether there is a satellite having acquired a precise image in an occurrence point vicinity at a time when a sound occurs and automatically acquire the image when available.

Alternatively, such a function is, for example, a function of accumulating a past history in a database. By analyzing the history, visualization of a seasonal trend or the like becomes possible, and thereby this matter may be useful for analyzing a cause.

### <Data Processing to be Executed by Unconfirmed Sound Information Processing Unit 120>

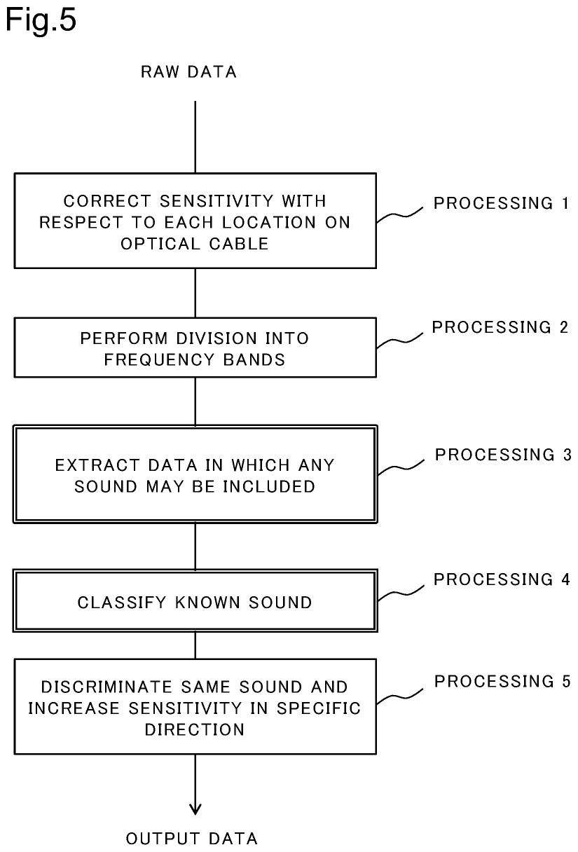

FIG. 5 is a conceptual diagram illustrating a data processing example of analyzing/evaluating sound data to be executed by the unconfirmed sound information processing unit 120. Among processing 1 to processing 5, processing conceivable to be executed in most application scenes is processing 4, and pieces of processing other than processing 4 are processing for increasing analysis performance for a sound and therefore, may not necessarily be executed. When certain processing is not executed, data having been processed in the last processing are processing target data for the following processing as are.

The above-described RAW data are input to the unconfirmed sound information processing unit 120 from the acquisition processing unit 101 in FIG. 1. The RAW data are data representing an instant intensity (waveform) of a sound detected by an optical fiber at each time and in each measurement point (sensor location) of the optical fiber 200.

In the pre-processing unit 122, the RAW data are provided with geographic coordinates with respect to a measurement point. In a stage of the RAW data, location information of a measurement point is represented by a location (e.g., a distance from a cable end) on a cable.

In contrast, geographic coordinate data in which a cable is installed are stored in the cable route information storage unit 133. Both data are collated and thereby, geographic coordinates of each point of the cable are previously determined and are previously stored in the cable route information storage unit 133, whereby geographic coordinates are provided for the RAW data. The RAW data subjected to pre-processing are stored in the RAW data storage unit 132.

[Processing 1: Sensitivity Correction with Respect to Each Location on Optical Cable]

Processing 1 is processing of selecting whether to be executed according to an application status of the unconfirmed sound extraction device 140 in FIG. 1. Processing 1 is executed, when executed, for example, by the pre-processing unit 122.

In a feature in a configuration according to the present invention, a cable itself is used as a sensor (underwater microphone), and therefore an underwater microphone or an underwater device is not required. Thereby, a matter that the number of devices is increased according to the number of observation points and then a cost is increased can be avoided, and in addition, an electronic circuit is not required under water and therefore, it is easy to ensure long-period reliability. In contrast, a characteristic as a sensor is not calibrated as in an underwater microphone, and therefore there is a problem in that a transfer function (filter function) for attenuating or emphasizing a specific frequency range is applied. In addition, there is a problem in that the transfer function is different depending on a type of a cable, an installation status thereof, or the like. These problems are desirably corrected for classification of a sound and the like to be described later.

### [Non-Uniformity of Sensor Characteristic: Difference in Cable Type and the Like and Correction]

The submarine cable 920 that acquires environment information is different in a type of a cable and an installation construction method thereof depending on an installation location. Due to this, a characteristic of the submarine cable 920 as a sensor is different with respect to each location.

Herein, the difference in a cable type includes, for example, a difference in a cross-section structure according to usage for transmission/communication or the like, a difference in a structure of a protection covering (presence/absence of exterior iron wiring and a type of the wiring), and the like. The difference in an installation construction method is a difference, for example, in a construction method of merely placing a cable on the sea bottom surface or in a construction method of digging a channel on the sea bottom and burying a cable in the channel.

These differences in a transfer function with respect to each location of a cable are recognized by referring to a production record and a construction record, and these records are recorded, for example, in the cable route information storage unit 133. A difference in a transfer function caused by this difference can be substantially uniquely corrected with respect to each location of the submarine cable 920. A specific correction method is a method of increasing, for example, by using a filter, an amplitude of a specific frequency band.

Herein, with regard to an influence depending on the difference in a cable type or a construction method, it is desirable to previously perform an experiment and recognize a transfer function using, as a reference, sound data acquired by an underwater microphone.

[Non-Uniformity of Sensor Characteristic: Difference with Respect to Each Actual Location and Calibration]

A factor of a variation in a sensor characteristic in each measurement point of a laid submarine cable 920 may not always be determined (estimated) uniquely based on the above-described construction method record or the like. The reason is that even when, for example, a record indicating that burial is performed in a uniform depth is present, actually, a burying depth may vary according to each location or covered earth and sand may be partially caused to flow and then exposed.

For the problem, a method for calibration by using, as a reference sound, a sound propagating to an actual location in a wide range is conceivable. As the reference sound, a sound generated naturally is usable, in addition to an artificial sound. Usage of a sound of a marine creature in which a feature of an emitted sound is well-known, for example, as in a whale is conceivable. In a case of a sound propagating in a wide range, substantially same sounds are sensed in points on the submarine cable 920, and therefore the unconfirmed sound information processing unit 120 determines a correction coefficient for each point in such a way as to cause these sounds to approach the same sound or to cause these sounds to approach a value according to a distance from a sound source.

Correction for the difference may not always be performed for an acquisition data side, and a method applied to a classification condition side to be described later is also conceivable. When, for example, there is a characteristic in which a high frequency side of environment information is attenuated according to a structure of a cable, a high frequency side of a classification condition is attenuated according to a cable type in an acquisition location without correction of acquisition data, and thereby matching in pattern discrimination is easily achieved. However, in general, correction of an acquisition data side is more advantageous in a versatility increase of data usage or the like and is considered preferable.

Based on the calibration, it can be recognized whether each point on the submarine cable 920 is suitable for acquisition of a sound. For example, it is difficult to thoroughly correct a certain point since sensitivity of the point is very low, and a certain point is likely to resonate in a specific frequency band and in addition, it is difficult to correct this point. These points having slight difficulty in environment acquisition can be extracted, for example, by comparison with a moving average value of measurement values with respect to anteroposterior measurement points on the cable. Therefore, these points having difficulty are excluded while attention is paid to a distribution of observation points, and data from a point where it is conceivable that substantially-average environment information having been able to be acquired is used, and thereby observation performance can be improved.

[Processing 2: Division into Frequency Bands]

Processing 2 is processing of selecting whether to be executed according to an application status of the unconfirmed sound extraction device 140. Processing 2 is executed, when executed, for example, by the pre-processing unit 122.

Herein, division with respect to each frequency band indicates that sound data are divided with respect to each frequency band, for example, as in 0.1 Hz from an extremely low frequency, 1 Hz from 0.1 Hz, 10 Hz from 1 Hz, 100 Hz from 10 Hz, and 100 Hz or more. Setting of the frequency band is desirably executed in such a way as to roughly perform classification, based on a sound field of a known sound.

There are roughly two reasons for dividing and evaluating sound data with respect to each frequency band. One reason is that a frequency band of a known sound is roughly divided according to a type of a sound source. When division is performed with respect to each frequency band, analog determination is easily performed in classification processing to be described later.

Another reason is that a large sound of no interest is excluded. In a location where a sound of no interest is large, for example, as in a location where waves crash on a shore, sound data are divided with respect to each frequency band, and in a frequency band where while a sound caused by breaking of waves is not excessively large, a known sound is present to a relatively-large extent, classification processing, to be described later, is executed. In this case, an influence of a sound of no interest on evaluation of a known sound can be reduced.

From such reasons, sound data are divided and evaluated with respect to each frequency band.

[Processing 3: Extraction of Data in which Certain Sound May be Included]

Processing 3 is processing of selecting whether to be executed according to an application status of the unconfirmed sound extraction device 140. Processing 3 is executed, when executed, for example, by the sound extraction unit 123. A method for the extraction is a method of extracting, for example, based on determination of whether a threshold is exceeded, a rapid change of an intensity of sound data from the last moving average trend.

Thereby, data having no possibility as sound data are excluded and a data amount to be processed hereinafter is reduced.

### [Processing 4: Classification of Known Sound]

Processing 4 is processing that is executed in many cases. Processing 4 is executed in the known sound classification unit 124.

The known sound classification unit 124 discriminates to what classification condition each piece of sound data stored in the extraction data storage unit 134 is similar and thereby, classifies the sound data. The classification is performed, for example, based on analog determination, by collating extraction data with a classification condition. Herein, the classification condition is information in which a discrimination condition for analogy determination and an occurrence cause name (occurrence cause ID) thereof are combined. The occurrence cause name includes, for example, waves, a marine creature, a machine such as a ship, a fish detector, an earthquake, and the like. The discrimination condition is, for example, a portion indicating a unique feature in sample data. The classification condition is previously stored in the classification condition storage unit 135. The known sound classification unit 124 stores, together with an occurrence cause ID, sound data classified into a type of interest in the known sound detection information storage unit 136. The known sound classification unit 124 stores, as unconfirmed sound data, sound data not similar to any classification condition in the unconfirmed sound detection information storage unit 137.

The classification condition is, for example, information relating to a frequency of a detected sound. For example, a sound emitted undersea by some sort of a marine creature may have a unique frequency, and in this case, based on a frequency of the sound, the sound emitted by the marine creature can be classified. As information relating to the frequency, for example, a median frequency or a frequency band are assumed.

The classification condition is alternatively, for example, an interval of a sound or alternatively is a pattern of a sound representing temporal transition of a frequency band of a sound.

A technique of automatically discriminating a type of a living object or the like from a sound collected by an underwater microphone is being actively studied and developed. The unconfirmed sound extraction device 140 executes similar processing for sound data acquired by optical fiber sensing. Details are described later in [Details of Processing 4].

### [Processing 5: Discrimination of Same Sound and Increasing Sensitivity in Specific Direction]

Processing 5 is processing of selecting whether to be executed according to an application status of the unconfirmed sound extraction device 140. Processing 5 is executed, when executed, for example, by the known sound classification unit 124.

A sound emitted in a location distant from an optical cable spreads concentrically or spherically and may be detected in a plurality of locations of the optical cable. Therefore, the known sound classification unit 124 further analyzes geographic coordinates of a measurement point where similar sounds have been detected and time information, and thereby estimates that the similar sounds indicate one sound emitted from a certain sound source and discriminates the sound. Similarity herein is similarity between sounds detected substantially at the same time in a plurality of locations close to the optical cable and is not similarity to a known sound. Processing of re-recognizing same sounds detected in a plurality of locations as one sound is executed without limitation to a known sound and an unconfirmed sound.

As one example, a sound of gunfire of an air gun for an underground structure survey or the like is considered. The sound of gunfire spreads concentrically or spherically and is detected in a plurality of locations of an optical cable. The known sound classification unit 124 detects that there are similar sounds in a close time range and a close distance range. The known sound classification unit 124 estimates and discriminates that these are sounds having the same source.

In this manner, a matter that when one sound is detected in a plurality of points on a cable, it is necessary to discriminate the sound as one sound is relevant to a case where sound sources are present in a location distant from the cable and a distance between the sound sources is sufficiently separated from a spatial resolution of optical fiber sensing.

A further-elongated optical fiber itself is used as a sensor array, and by using a well-known sound source separation technique, a spatial location of a sound source can be estimated. Thereby, for example, an operation of increasing sensitivity for a sound from a direction of a sound of interest and decreasing sensitivity for a sound from a direction other than the former direction is performed, and thereby an unconfirmed sound as half-buried in background noise can be easily detected. When sound data acquired from an optical fiber are recorded, such an operation can be performed later. The sound source separation technique referred to herein is, for example, a beam forming technique.

### [Details of Processing 4: Classification Method of Known Sound]

A method for classification processing to be executed by the known sound classification unit 124 is roughly classified into two methods. One method is referred to as a voiceprint discrimination technique and is a method of previously finding a discrimination condition including a combination of conditions for a plurality of feature amounts for discriminating a type of a sound emitted from a marine creature or the like and performing discrimination, based on the discrimination condition. A specific example of the method is described later. Another method is machine learning, specifically, a method referred to as deep learning, the method including inputting a large number of pieces of data attached with a label indicating what the data indicate to a neural network of a multilayer hierarchy, causing the large number of pieces of data to be learned, acquiring a learned model, and using the model for discrimination. These discrimination methods are examples and may be used in combination, or a newly-developed analysis method is usable.

An example to be explained below is an example in the former case in which discrimination is performed by using a classification condition, i.e., a discrimination condition including a combination of conditions for a plurality of feature amounts. In a method using a learned model, a classification condition is not required, but herein, a specific explanation of the method is omitted and four specific examples for a method of performing analogy determination by using a classification condition are explained. These are examples of a part of a process of analogy determination and the whole process is not explained.

A first specific example of a classification operation of the known sound classification unit 124 is explained.

Herein, it is assumed that a matter that “when a frequency of a sound falls within an allowable width±B [Hz] around AAA [Hz] as the center, the sound is a cry of a marine creature CCC” is stored in the classification condition storage unit 135 as a classification condition. Herein, it is assumed that a value B is a sufficiently small value, compared with a value AAA.

Herein, it is assumed that a frequency of a sound included in extraction data read from the extraction data storage unit 134 falls within AAA±B [Hz]. In this case, the known sound classification unit 124 classifies the sound included in the extraction data as a cry of the marine creature CCC and stores the classified extraction data in the known sound detection information storage unit 136.

A second specific example of the classification operation of the known sound classification unit 124 is explained.

Herein, it is assumed that a matter that “when a time interval of a sound falls within an allowable width±E seconds around DDD seconds as the center, the sound is a cry of a marine creature CCC” is stored in the classification condition storage unit 135 as a classification condition. Herein, it is assumed that a value E is a sufficiently small value, compared with a value DDD.

Herein, it is assumed that a time interval of a sound included in extraction data read from the extraction data storage unit 134 falls within DDD±E seconds. In this case, the known sound classification unit 124 classifies the sound included in the extraction data as a cry of the marine creature CCC and stores the classified extraction data in the known sound detection information storage unit 136.

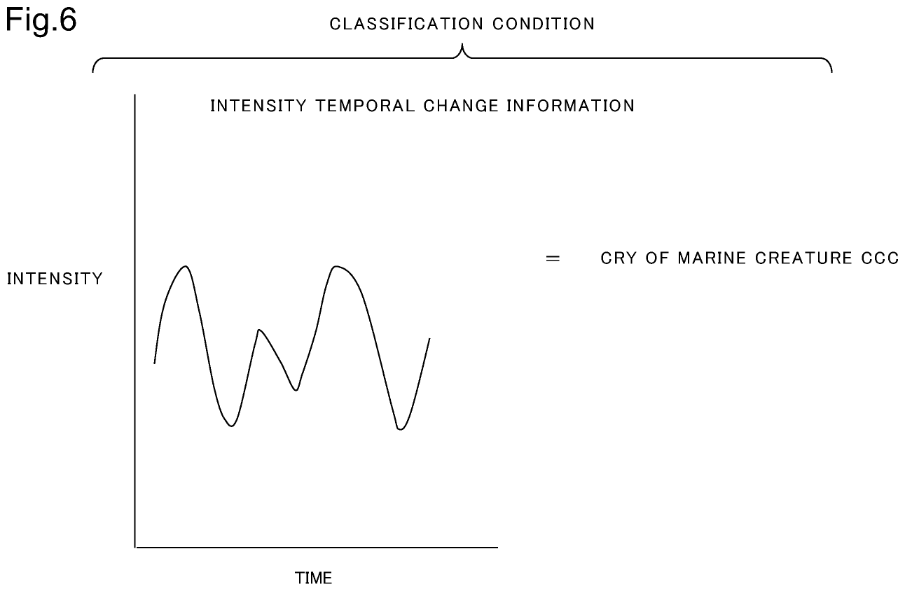

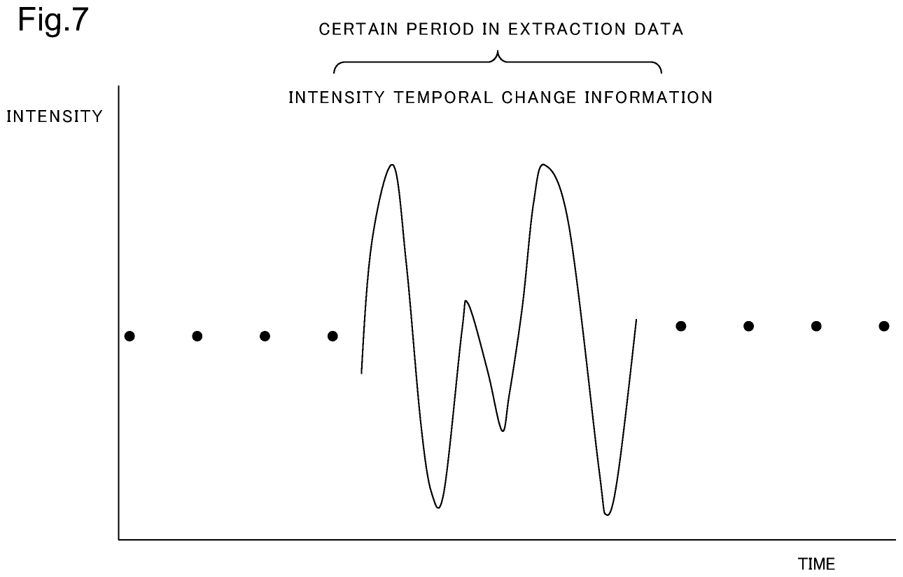

A third specific example of the classification operation of the known sound classification unit 124 is explained with reference to FIGS. 6 and 7.

Herein, it is assumed that a matter that “a temporal change pattern of an intensity of a sound illustrated in FIG. 6 is a cry of a marine creature CCC” is stored in the classification condition storage unit 135 as a classification condition.

Herein, it is assumed that in extraction data read from the extraction data storage unit 134, a period including an intensity temporal change in FIG. 7 is included. The known sound classification unit 124 performs analog determination between the pattern of the intensity temporal change in FIG. 6 and a waveform of the extraction data and determines that in the extraction data, the pattern in FIG. 6 being a classification condition is present with a strong correlation in the form in FIG. 7. The known sound classification unit 124 executes the determination processing, for example, by calculating a general mutual correlation coefficient. The known sound classification unit 124 classifies the sound included in the extraction data as a cry of the marine creature CCC and stores the classified extraction data in the known sound detection information storage unit 136.

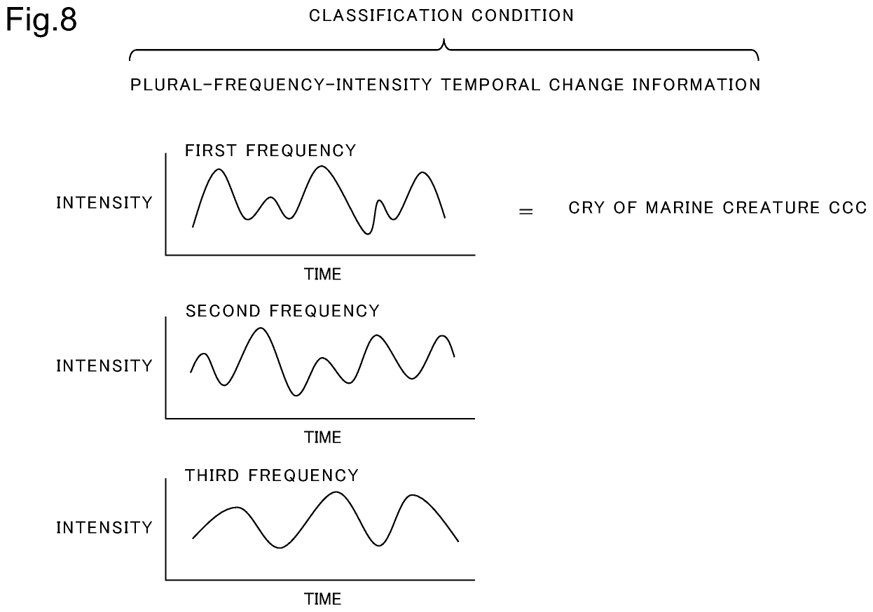

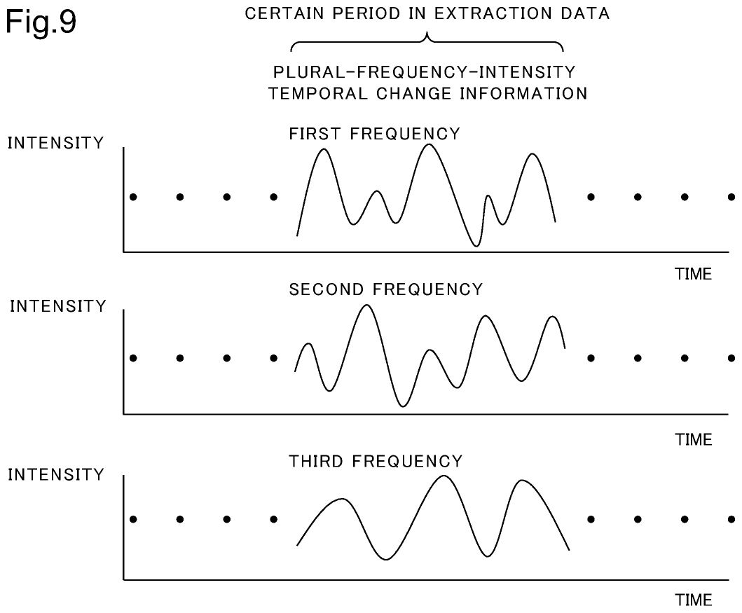

A fourth specific example of the classification operation of the known sound classification unit 124 is explained with reference to FIGS. 8 and 9.

Herein, it is assumed that a matter that “a pattern of temporal change information of an intensity of a sound with respect to a plurality of frequencies (plural-frequency-intensity temporal change information) illustrated in FIG. 8 indicates a cry of a marine creature CCC” is stored in the classification condition storage unit 135 as a classification condition.

Herein, it is assumed that in extraction data read from the extraction data storage unit 134, a period including plural-frequency-intensity temporal change information in FIG. 9 is included. The known sound classification unit 124 performs analog determination between the pattern of the plural-frequency-intensity temporal change information and determines that in the extraction data, the pattern in FIG. 8 being a classification condition is present with a strong correlation in the form in FIG. 9. The known sound classification unit 124 executes the determination processing, for example, by calculating a general mutual correlation coefficient. The known sound classification unit 124 classifies a sound included in the extraction data as a cry of the marine creature CCC and stores the classified extraction data in the known sound detection information storage unit 136.

### ADVANTAGEOUS EFFECT

The unconfirmed sound extraction device according to the present example embodiment acquires peripheral sound data by using an optical cable. Therefore, the unconfirmed sound extraction device according to the present example embodiment enables, for example, by being added to a communication cable system or the like that installs an optical fiber cable on the sea bottom, monitoring, with a small cost burden, of occurrence of an unconfirmed sound in which it is not known where and when such a sound occurs in the vast sea.

The unconfirmed sound extraction device according to the present example embodiment outputs, from sound data acquired by using DAS explained in the paragraph of Background Art, sound data in which an occurrence cause can be classified and sound data in which an occurrence cause has been not capable of being classified. Therefore, a monitoring worker or the like easily seeks, by work, from unconfirmed sound data being further-narrowed sound data, confirmation of presence of a sound based on an event having a small appearance frequency, for example, such as a fall of a meteorite or an airplane. The reason is that a known sound which can be automatically classified is sieved and thereby, unconfirmed sound data having unknown causes are narrowed down.

Thereby, the unconfirmed sound extraction device according to the present example embodiment eases monitoring of a sound based on an event having a small appearance frequency over a vast marine area.

The unconfirmed sound extraction device according to the present example embodiment may classify and output sound data from which an occurrence cause can be classified even when the sound data are based on an event having a small appearance frequency, for example, such as a fall of a meteorite or an airplane onto the sea surface. In the examples explained above, a case where an optical cable including an optical fiber is a submarine cable has been mainly explained. However, the optical cable may be an optical cable installed in a bay, the sea other than ocean water such as the Caspian Sea, a lake, a river, or a canal. In addition, the optical cable may be an optical cable installed on ashore or in the ground.

### <Minimum Example Embodiment Configuration>

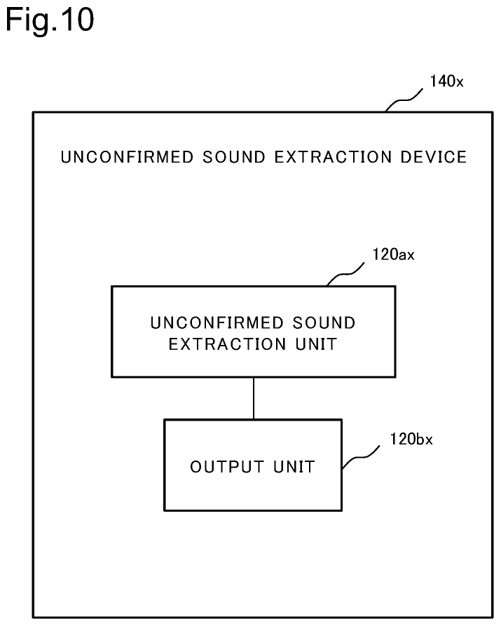

FIG. 10 is a block diagram illustrating a configuration of an unconfirmed sound extraction device 140x being a minimum configuration of the unconfirmed sound extraction device according to the example embodiment. The unconfirmed sound extraction device 140x includes an unconfirmed sound extraction unit 120ax and an output unit 120bx. The unconfirmed sound extraction unit 120ax extracts, from sound data, unconfirmed sound information representing unconfirmed sound data being the sound data of the sound in which an occurrence cause is not capable of being estimated at a time and in the location of acquisition of the sound data. The sound data are data that are acquired by an optical fiber and that relate to a sound in each of locations of the optical fiber. The output unit 120bx outputs the unconfirmed sound information.

The unconfirmed sound extraction device 140x acquires the unconfirmed sound information by using the optical fiber. The unconfirmed sound information is relevant to information acquired by excluding, from the sound data, sound data in which an occurrence cause is classified. Therefore, a worker or the like may examine whether the sound data in a smaller range are relevant to a sound in which an event having a small appearance frequency is a cause. Therefore, the unconfirmed sound extraction device 140x eases monitoring of a sound in which an event having a small appearance frequency is a cause.

Therefore, the unconfirmed sound extraction device 140x exhibits, based on the configuration, the advantageous effect described in the paragraph of [Advantageous Effects of Invention].

While the example embodiments according to the present invention have been explained, the present invention is not limited to the example embodiments, and further modifications, substitutions, and adjustments may be added without departing from the fundamental technical spirit of the present invention. For example, a configuration of elements illustrated in each of the drawings is one example for assisting understanding of the present invention without limitation to these configurations illustrated in the drawings.

The whole or part of the example embodiments described above can be described as, but not limited to, the following supplementary notes.

### (Supplementary Note 1)

An unconfirmed sound extraction device including:
an unconfirmed sound extraction unit that extracts, from sound data being acquired by an optical fiber, the sound data being data relating to a sound in each of locations of the optical fiber, unconfirmed sound information representing unconfirmed sound data being the sound data of the sound an occurrence cause of which is not estimated at a time and in the location of acquisition of the sound data; and an output unit that outputs the unconfirmed sound information.

### (Supplementary Note 2)

The unconfirmed sound extraction device according to supplementary note 1, wherein the unconfirmed sound extraction unit performs collation with a previously-stored classification condition and extracts, as the unconfirmed sound data, the sound data not relevant to a sound of a known type.

### (Supplementary Note 3)

The unconfirmed sound extraction device according to supplementary note 2, wherein the output unit also outputs, from sound data relevant to a sound of the known type, sound data of a previously-determined type together with the type.

### (Supplementary Note 4)

The unconfirmed sound extraction device according to supplementary note 2 or 3, wherein, whether to be relevant to a sound of the known type in the unconfirmed sound extraction unit is determined based on analogy determination via collation with a previously-stored classification condition, by using one feature or more as a key.

### (Supplementary Note 5)

The unconfirmed sound extraction device according to supplementary note 4, wherein relevance determination for a sound of the known type in the unconfirmed sound extraction unit is performed after the sound data are divided into a plurality of frequency bands.

### (Supplementary Note 6)

The unconfirmed sound extraction device according to supplementary note 5, wherein the unconfirmed sound extraction unit performs, based on a feature amount of the sound data, the relevance determination, and the feature includes at least any one of a frequency, a temporal change of a frequency, and a temporal change of an intensity envelope with respect to a sound.

### (Supplementary Note 7)

The unconfirmed sound extraction device according to supplementary note 6, wherein the unconfirmed sound extraction unit discriminates a sound emitted from a same sound source, from among sounds detected in a plurality of the locations of the optical fiber.

### (Supplementary Note 8)

The unconfirmed sound extraction device according to any one of supplementary notes 1 to 7, wherein the unconfirmed sound extraction unit monitors, by increasing sensitivity in a predetermined direction, sounds detected in a plurality of the locations of the optical fiber, the sounds being used as sensor array output.

### (Supplementary Note 9)

The unconfirmed sound extraction device according to any one of supplementary notes 1 to 8, wherein the optical fiber is included in an optical cable.

### (Supplementary Note 10)

The unconfirmed sound extraction device according to supplementary note 9, wherein the unconfirmed sound extraction unit executes, based on information of an installation construction method relevant to installation of the optical cable, processing of reducing, from the sound data, an influence on sensitivity due to a difference in the installation construction method.

### (Supplementary Note 11)

The unconfirmed sound extraction device according to supplementary note 9 or 10, wherein the unconfirmed sound extraction unit executes, based on information representing a cable type of the optical cable, processing of reducing, from the sound data, an influence on sensitivity due to a difference in the cable type.

### (Supplementary Note 12)

The unconfirmed sound extraction device according to any one of supplementary notes 9 and 10, wherein the unconfirmed sound extraction unit executes processing of acquiring, by using a reference sound propagating in a wide range of the optical cable, a degree of a difference in the sound data due to the location where the sound data are acquired, and, based on information of the degree of the difference, reducing, from the sound data, a difference in sensitivity due to the location where the sound data are acquired, or selects a location for acquiring the sound data.

### (Supplementary Note 13)

The unconfirmed sound extraction device according to any one of supplementary notes 9 to 12, wherein an optical fiber core wire is divided or a wavelength is divided, whereby the optical cable is shared with another application.

### (Supplementary Note 14)

The unconfirmed sound extraction device according to any one of supplementary notes 1 to 13, wherein the acquisition by the optical fiber is performed by using optical fiber sensing.

### (Supplementary Note 15)

The unconfirmed sound extraction device according to supplementary note 14, wherein the optical fiber sensing is distributed acoustic sensing.

### (Supplementary Note 16)

The unconfirmed sound extraction device according to any one of supplementary notes 1 to 15, further including an acquisition processing unit that acquires the sound data by the optical fiber and transmits the acquired sound data to the unconfirmed sound extraction unit.

### (Supplementary Note 17)

An unconfirmed sound extraction system including: the unconfirmed sound extraction device according to any one of supplementary notes 1 to 16; and the optical fiber.

### (Supplementary Note 18)

An unconfirmed sound extraction method including:
extracting, from sound data being acquired by an optical fiber, the sound data being data relating to a sound in each of locations of the optical fiber, unconfirmed sound information representing unconfirmed sound data being the sound data of the sound an occurrence cause of which is not estimated at a time and in a location of acquisition of the sound data; and
outputting the unconfirmed sound information.

### (Supplementary Note 19)

An unconfirmed sound extraction program causing a computer to execute:
processing of extracting, from sound data being acquired by an optical fiber, the sound data being data relating to a sound in each of locations of the optical fiber, unconfirmed sound information representing unconfirmed sound data being the sound data of the sound an occurrence cause of which is not estimated at a time and in a location of acquisition of the sound data; and
processing of outputting the unconfirmed sound information.

### (Supplementary Note 20)

The unconfirmed sound extraction device according to supplementary note 2, wherein the unconfirmed sound extraction unit excludes, with respect to even sound data not relevant to the known sound, from the unconfirmed sound data, the sound data of the sound the occurrence cause of which is classified based on at least any one of the location, the time, and a frequency of the sound.

### (Supplementary Note 21)

The unconfirmed sound extraction device according to any one of supplementary notes 1 to 8, wherein the unconfirmed sound extraction unit corrects the sound data, based on correction sound data being data relating to a sound separately acquired.

### (Supplementary Note 22)

The unconfirmed sound extraction device according to supplementary note 9, wherein the optical cable is a cable for optical communication.

### (Supplementary Note 23)

The unconfirmed sound extraction device according to supplementary note 1, wherein the unconfirmed sound extraction unit associates the location where the sound data are acquired with geographic coordinates.

### (Supplementary Note 24)

The unconfirmed sound extraction device according to supplementary note 1, wherein the unconfirmed sound extraction unit excludes, from the sound data, the sound data not including a sound other than background noise, and then performs the extraction.

Herein, the optical fiber in the supplementary notes is, for example, the optical fiber 200 in FIG. 1 or an optical fiber included in the submarine cable 920 in FIG. 2. The unconfirmed sound information acquisition unit is, for example, a portion of the unconfirmed sound information processing unit 120 in FIG. 1 for acquiring, from the sound data, the unconfirmed sound information at a time when the acquisition processing unit acquires the sound data.

The output unit is, for example, a portion of the unconfirmed sound information processing unit 120 for outputting the unconfirmed sound information. The unconfirmed sound extraction device is, for example, the unconfirmed sound extraction device 140 in FIG. 1.

The optical cable is, for example, the submarine cable 920 in FIG. 2. The acquisition processing unit is, for example, the acquisition processing unit 101 in FIG. 1. The unconfirmed sound extraction system is, for example, the unconfirmed sound extraction system 300 in FIG. 1. The computer is, for example, a computer included in the acquisition processing unit 101 and the unconfirmed sound information processing unit 120 in FIG. 1. The unconfirmed sound extraction program is a program causing the computer to execute processing.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2020-136554, filed on Aug. 13, 2020, the disclosure of which is incorporated herein in its entirety by reference.

### REFERENCE SIGNS LIST

100 Interrogator
101 Acquisition processing unit
103 Light source unit
104 Modulation unit
105 Detection unit
120ax Unconfirmed sound extraction unit
120bx Output unit
121 Processing unit
122 Pre-processing unit
123 Sound extraction unit
124 Known sound classification unit
125 Output processing unit
131 Storage unit
132 RAW data storage unit
133 Cable route information storage unit
134 Extraction data storage unit
135 Classification condition storage unit
136 Known sound detection information storage unit
137 Unconfirmed sound detection information storage unit
140, 140x Unconfirmed sound extraction device
200, 201, 202 Optical fiber
211 Optical coupler
300 Unconfirmed sound extraction system
920 Submarine cable

What is claimed is:

1. An unconfirmed sound extraction device comprising:
an unconfirmed sound extractor configured to extract, from sound data being acquired by an optical fiber, the sound data being data relating to a sound in each of locations of the optical fiber, unconfirmed sound information representing unconfirmed sound data being the sound data of the sound an occurrence cause of which is not estimated at a time and in the location of acquisition of the sound data; and
an output configured to output the unconfirmed sound information.

2. The unconfirmed sound extraction device according to claim 1, wherein the unconfirmed sound extractor is configured to perform collation with a previously-stored classification condition and extract, as the unconfirmed sound data, the sound data not relevant to a sound of a known type.

3. The unconfirmed sound extraction device according to claim 2, wherein the output is configured to also output, from sound data relevant to a sound of the known type, sound data of a previously-determined type together with the type.

4. The unconfirmed sound extraction device according to claim 2, wherein, whether to be relevant to a sound of the known type in the unconfirmed sound extractor is determined based on analogy determination via collation with a previously-stored classification condition, by using one feature or more as a key.

5. The unconfirmed sound extraction device according to claim 4, wherein relevance determination for a sound of the known type in the unconfirmed sound extractor is performed after the sound data are divided into a plurality of frequency bands.

6. The unconfirmed sound extraction device according to claim 5, wherein the unconfirmed sound extractor is configured to perform, based on a feature amount of the sound data, the relevance determination, and the feature includes at least any one of a frequency, a temporal change of a frequency, and a temporal change of an intensity envelope with respect to a sound.

7. The unconfirmed sound extraction device according to claim 6, wherein the unconfirmed sound extractor is configured to discriminate a sound emitted from a same sound source, from among sounds detected in a plurality of the locations of the optical fiber.

8. The unconfirmed sound extraction device according to claim 1, wherein the unconfirmed sound extractor is configured to monitor, by increasing sensitivity in a predetermined direction, sounds detected in a plurality of the locations of the optical fiber, the sounds being used as sensor array output.

9. The unconfirmed sound extraction device according to claim 1, wherein the optical fiber is included in an optical cable.

10. The unconfirmed sound extraction device according to claim 9, wherein the unconfirmed sound extractor is configured to execute, based on information of an installation construction method relevant to installation of the optical cable, processing of reducing, from the sound data, an influence on sensitivity due to a difference in the installation construction method.

11. The unconfirmed sound extraction device according to claim 9, wherein the unconfirmed sound extractor is configured to execute, based on information representing a cable type of the optical cable, processing of reducing, from the sound data, an influence on sensitivity due to a difference in the cable type.

12. The unconfirmed sound extraction device according to claim 9, wherein the unconfirmed sound extractor is configured to execute processing of acquiring, by using a reference sound propagating in a wide range of the optical cable, a degree of a difference in the sound data due to the location where the sound data are acquired, and, based on information of the degree of the difference, reducing, from the sound data, a difference in sensitivity due to the location where the sound data are acquired, or select a location for acquiring the sound data.

13. The unconfirmed sound extraction device according to claim 9, wherein an optical fiber core wire is divided or a wavelength is divided, whereby the optical cable is shared with another application.

14. The unconfirmed sound extraction device according to claim 1, wherein the acquisition by the optical fiber is performed by using optical fiber sensing.

15. The unconfirmed sound extraction device according to claim 14, wherein the optical fiber sensing is distributed acoustic sensing.

16. The unconfirmed sound extraction device according to claim 1, further comprising an acquisition processor configured to acquire the sound data by the optical fiber and transmit the acquired sound data to the unconfirmed sound extractor.

17. (canceled)

18. An unconfirmed sound extraction method comprising:
extracting, from sound data being acquired by an optical fiber, the sound data being data relating to a sound in each of locations of the optical fiber, unconfirmed sound information representing unconfirmed sound data being the sound data of the sound an occurrence cause of which is not estimated at a time and in a location of acquisition of the sound data; and
outputting the unconfirmed sound information.

19. A recording medium recording an unconfirmed sound extraction program causing a computer to execute:
processing of extracting, from sound data being acquired by an optical fiber, the sound data being data relating to a sound in each of locations of the optical fiber, unconfirmed sound information representing unconfirmed sound data being the sound data of the sound an occurrence cause of which is not estimated at a time and in a location of acquisition of the sound data; and
processing of outputting the unconfirmed sound information.

20. The unconfirmed sound extraction device according to claim 2, wherein the unconfirmed sound extractor is configured to exclude, with respect to even sound data not relevant to the known sound, from the unconfirmed sound data, the sound data of the sound the occurrence cause of which is classified based on at least any one of the location, the time, and a frequency of the sound.

21. The unconfirmed sound extraction device according to claim 1, wherein the unconfirmed sound extractor is configured to correct the sound data, based on correction sound data being data relating to a sound separately acquired.

22-24. (canceled)
